(19) United States
(12) Patent Application Publication
(10) Pub. No.: US 2026/0081787 A1
(43) Pub. Date: Mar. 19, 2026

(54) Artefact Of A Container Instance, Which Artefact Is Signable In A Cascaded Manner

(71) Applicant: Siemens Aktiengesellschaft, München (DE)

(72) Inventor: Christian Knierim, München (DE)

(73) Assignee: Siemens Aktiengesellschaft, München (DE)

(21) Appl. No.: 19/106,326

(22) PCT Filed: Aug. 16, 2023
(86) PCT No.: PCT/EP2023/072509

§ 371 Date: Feb. 25, 2025

(30) Foreign Application Priority Data
Aug. 26, 2022 (EP) 22192462.4

(51) Int. Cl. H04L 9/32

(52) U.S. Cl. CPC H04L 9/3247

(57) ABSTRACT

Various embodiments of the teachings herein include an artifact for an instantiation and/or configuration of a container instance for a container runtime environment. An example includes: a first parameter featuring a first cryptographic signature; a second parameter; and an explicit specification of the second parameter with regard to signability by a second cryptographic signature. The second parameter does not feature a cryptographic signature and/or the second parameter is modifiable.

### CROSS-REFERENCE TO RELATED APPLICATIONS

This application is a U.S. National Stage Application of International Application No. PCT/EP2023/072509 filed Aug. 16, 2023, which designates the United States of America, and claims priority to EP Application No. 22192462.4 filed Aug. 26, 2022, the contents of which are hereby incorporated by reference in their entirety.

### TECHNICAL FIELD

The present disclosure relates to container runtime environments. Various embodiments of the teachings include artifacts for an instantiation and/or configuration of a container instance for a container runtime environment, associated container instances, container runtime environments, and methods for creating an artifact for an instantiation and/or configuration of a container instance for a container runtime environment.

### BACKGROUND

In order to provide container images and the container deployment configuration thereof with integrity protection and authenticity protection, container images and the container deployment configuration—both may also generally be designated as a “container artifact”—can both be signed. In most container-signature methods, the problem arises that container images, to the extent that they are being copied to another registry, have to be re-signed, since the uniform resource locator (URL) of the registry is included in the calculation of the signature. If in a containerized environment it is desired to make containerized components available in different registries (at the customer and at their customers), such signature methods can only be employed to a limited extent, since a renewed signature procedure is required in each registry, and the validation of the original information made available in the first registry (at the manufacturer or creator) is lost.

By renewed signature, however, the party who receives a component and who would like to process it further (in particular, to execute it in a runtime environment or to integrate it into further processing processes such as image-creation) cannot check whether the container images made available in a downstream registry are authentic or have been modified by the operator of the downstream registry. The same applies to the operator of a containerized industrial IoT runtime environment (which, for example, is made available in an Edge device) who would like to detect that the app, consisting of one or more container instances, that is present in the device and in a container runtime environment does in fact come from the original creator.

There are various signature methods for container images, such as Notary Version 1, Notary Version 2, Cosign or Red Hat container signing, which assist the signature of artifacts such as container images and deployment configurations and are also employed in the sphere of containers. All these methods use the basic principle that an artifact, once signed, is immutable and also has to be signed again after an amendment has been made. Notary Version 1, Cosign and Red Hat container signing are additionally based on the fact that the URL of the registry—that is to say, the original location—of a container image is incorporated into the calculation of the signature.

In addition, in the case of Notary Version 1, Cosign, and Red Hat container signing the signatures are not an integral part of the signed artifact but rather have been stored externally and, for instance, filed in a registry. If a relocation of the signed artifact to another registry takes place, a renewed signature procedure has to take place, so the original context of the build artifact, in particular of the container image or of the deployment configuration, is lost.

In the case of Notary v2, the signature is an integral part of the image, and accordingly a so-called ORAS manifest is added to the container image. According to the Notary v2 specification, it is also explicitly possible that it can be defined that particular areas of an artifact are to be excluded from the signature. A relocation of the image is consequently possible, but the tools, such as notation for signature generation and validation, do not offer the creator of the signature a possibility for controlling which parameters of a build artifact are to be incorporated for the purpose of signature calculation and which are not to be incorporated, so that in the course of the generation of a signature the scope of the securing of integrity and authenticity cannot be defined, or several signatures that refer to different areas of the artifact (deployment configuration or container image) can be applied simultaneously.

### SUMMARY

The teachings of the present disclosure may make available an artifact for an instantiation and/or configuration of a container instance for a container runtime environment, said artifact being improved with regard to integrity and authenticity. For example, some embodiments include an artifact for an instantiation and/or configuration of a container instance for a container runtime environment, featuring: at least one first parameter, the at least one first parameter featuring a first cryptographic signature, at least one second parameter, and an explicit specification of the at least one second parameter with regard to signability by a second cryptographic signature, wherein the at least one second parameter does not feature a cryptographic signature, and/or wherein the at least one second parameter is modifiable.

In some embodiments, the at least one first cryptographic signature protects the at least one first parameter against modification.

In some embodiments, there is no overlap between the at least one first parameter and the at least one second parameter.

In some embodiments, the at least one first parameter and/or the at least one second parameter take(s) the form of: a unique identifier and/or a reference and/or an initial uniform resource locator and/or a container-image uniform resource locator and/or an initial container-image tag and/or binary-large-object information and/or a container-image label.

In some embodiments, the at least one first cryptographic signature specifies the at least one first parameter.

In some embodiments, the artifact and/or the at least one first cryptographic signature feature(s): metadata, the metadata specifying the at least one first parameter, and the metadata featuring integrity protection and authenticity protection.

In some embodiments, the first cryptographic signature features a reference to the at least one second parameter.

In some embodiments, the artifact further comprises: at least one data area featuring the at least one first parameter and/or at least one second data area featuring the at least one second parameter.

In some embodiments, a signature-depth value has been assigned to the at least one second signature, the signature-depth value indicating a maximum possible number of signatures permitted for the artifact.

In some embodiments, the artifact further comprises at least one third parameter, the at least one third parameter being signable by at least one third cryptographic signature.

In some embodiments, the artifact comprises: a container deployment configuration or a container image.

As another example, some embodiments include a container instance based on an artifact as described herein.

In some embodiments, some embodiments include a container runtime environment featuring at least one container instance as described herein.

In some embodiments, some embodiments include a method for creating an artifact for an instantiation and/or configuration of a container instance for a container runtime environment, including: examining at least one first cryptographic signature which signs a first parameter, depending on an outcome of the examination, creating at least one second cryptographic signature which signs a second parameter, wherein the first parameter and the second parameter are featured by an artifact as described herein.

### BRIEF DESCRIPTION OF THE DRAWINGS

The special features and advantages of the teachings of the present disclosure are apparent from the following explanatory remarks pertaining to several embodiment examples with reference to the schematic drawings. In the drawings:

FIG. 1 shows a flowchart of an example method incorporating teachings of the present disclosure with the stations involved for the purpose of creating the signature; and

FIG. 2 shows a flowchart of an example method including a sequence of operations required for the purpose of creating a second signature.

### DETAILED DESCRIPTION

The teachings of the present disclosure relate to artifacts for an instantiation and/or configuration of a container instance for a container runtime environment, featuring: at least one first parameter, the at least one first parameter featuring a first cryptographic signature, at least one second parameter, and an explicit specification of the at least one second parameter with regard to signability by a second cryptographic signature, wherein the at least one second parameter does not feature a cryptographic signature, and/or wherein the at least one second parameter is modifiable. The at least one second parameter does not feature a cryptographic signature.

The at least one second parameter is modifiable. The term “modifiable” here may also be designated as “changeable”. The at least one second parameter is consequently capable of being changed in a downstream registry or by a user and/or customer. The at least one second parameter is consequently not established by the manufacturer and is not subject to monitoring by the manufacturer.

The signability by the second cryptographic signature of the at least one second parameter means that the at least one second parameter is signable by at least one second cryptographic signature. This is specified explicitly with respect to the artifact.

The explicit specification of the at least one second parameter may feature further details relating to the at least one second parameter (name, location, reference). But it is also indicated explicitly, as claimed, that the at least one second parameter can be signed.

The first cryptographic signature may also be designated as the “preceding signature”. The second cryptographic signature may also be designated as the “subsequent signature”.

Some embodiments provide a deployment configuration or a container image:
can be signed several times by different entities, and
the creator of the preceding signature can control within this signature precisely which areas of the artifact are permitted to be changed, since these parameters are not a basis of the signature.

The teachings herein consequently make available signature methods that enables a creator to make an artifact available that can be changed by a later user in respect of the hitherto unsigned areas. The areas that can be changed by the later user are defined by the creator. Areas that the creator has already signed cannot be changed by the later user. The creator can consequently restrict the subsequently modifiable data. For the methods described herein, a preceding creator of the artifact can selectively clear areas of artifacts for subsequent process steps—that is to say, can leave them unsigned. These areas can then be modified or extended, then signed by the subsequent operators and therefore protected against further modification.

The term “areas” in the sense of the present disclosure mean metadata of the artifact, but not layers of a base image.

In some embodiments, the creator of a containerized application would possibly also like to be able to monitor the downstream registries in which an app is permitted to be made available, since registries that satisfy particular criteria are exclusively regarded as trustworthy. At the same time, in these trustworthy downstream registries it is to be allowed that particular information (such as, in particular, defined image tags) may be added or edited within an image, in order consequently to make it possible that customer-specific parameterizations in respect of the images can be implemented in a downstream registry.

The same requirement also applies to a deployment configuration that, where appropriate, references several signed images and at the same time is to be modified and extended in particular sections by the operators of individual registries, in order, for instance, to make possible company-specific security requirements within a central registry, in particular within an Industrial Edge Management, by allocation of particular deployment information such as tags or labels for the provision of meta-information or for the allocation or revocation of particular privileges.

Various embodiments consequently make available a solution that enables a developer of a deployment configuration or of a container image to secure the integrity and authenticity of his/her app across several downstream registries and, at the same time, to make possible certain amendments, cleared by the developer, within the downstream registries, which can then also be validated in the runtime environment. A possibility is consequently made available for an improved examination of integrity and authenticity across the processing chain for the container artifacts.

In some embodiments, the at least one first cryptographic signature protects the at least one first parameter against modification. The term “modification” may also be designated as a “change”. The at least one first parameter is consequently no longer capable of being changed in a downstream registry or by a user and/or customer. The at least one first parameter is consequently established by the manufacturer and is subject to monitoring by the manufacturer.

In some embodiments, there is no clash between the at least one first parameter and the at least one second parameter. The term “clash” may also be designated as an “overlap”. The at least one first parameter and the at least one second parameter are consequently separate.

In some embodiments, the at least one first parameter and/or the at least one second parameter take(s) the form of:
a unique identifier and/or
a reference and/or
an initial uniform resource locator and/or
a container-image uniform resource locator and/or
an initial container-image tag and/or
binary-large-object information and/or
a container-image label.

In the case of a container image, it can consequently be defined, for instance, that the initial uniform resource locator (URL) or the initial image tag is added, and a securing of the integrity and authenticity of the delivered binary-large-object (BLOB) information is created, but special image labels, for instance, are amended by the responsible integrator prior to filing in subsequent registries, and these labels are not to be included in the signature calculation.

The unique identifier takes the form, in particular, of a container-image label and/or a container-image tag. The reference for the layer to be signed takes the form, in some embodiments, of BLOB information. The initial uniform resource locator and/or the container-image uniform resource locator are references to the location of the image.

In some embodiments, the at least one first cryptographic signature specifies the at least one first parameter.

In his/her developer infrastructure, the creator of a container image consequently signs his/her artifact in his/her signature service and, in so doing, specifies which areas are to be included in the signature for the purpose of calculating the signature. Consequently, with the aid of the at least one first cryptographic signature it can be deduced by what means the first signature is formed. This can alternatively be indicated directly in the metadata of the first signature.

Parameters that are signed are consequently not initially indicated in the artifact; instead, parameters to be signed are predetermined by the creator of the first signature. Further restrictions—in particular, conditions for further signatures or for the second signature—are indicated after an initial signature—the first signature—in the respectively preceding signatures and/or are indicated in additional metadata introduced prior to the signature procedure, which, in turn, have been signed.

In some embodiments, the artifact and/or the at least one first cryptographic signature feature(s): metadata, metadata specifying the at least one first parameter, and the metadata featuring integrity protection and/or authenticity protection. Precisely which parameters are used for the purpose of creating the first signature is consequently defined in the metadata of the signature, which have likewise been secured as regards integrity and authenticity.

All the signatures may either be delivered within the artifact as part of the metadata or may be filed externally, in particular in a database, on a web server, in a blockchain or, as in the case of already existing solutions, within a code repository.

In some embodiments, the first cryptographic signature features a reference to the at least one second parameter. Precisely which parameters are incorporated for the purpose of calculation in the course of the creation of the second signature of the at least one second parameter is consequently deduced, on the one hand, from the predecessor signature, particularly if requirements such as a nesting-depth are specified, and, on the other hand, from a, where appropriate, artifact-specific parameter guideline filed locally by the creator of the signature.

The at least one second parameter is consequently defined directly or indirectly by the at least one first cryptographic signature. The artifact itself features the explicit specification of the at least one second parameter.

In some embodiments, the artifact features, in addition: at least one data area featuring the at least one first parameter and/or at least one second data area featuring the at least one second parameter.

Whenever the at least one data area is signed, not only is a parameter therefrom signed but rather the entire data area-that is to say, where appropriate, the whole section or a subset of the section, to the extent that this section has areas that can be changed for the subsequent steps, it being possible for this to be defined via and/or in the predecessor signatures.

Expressed otherwise, the at least one first parameter is consequently featured by the first data area of the artifact, and/or the at least one second parameter is featured by the second data area of the artifact. There is no overlap between the first data area and the second data area.

In some embodiments, a signature-depth value has been assigned to the at least one second signature, the signature-depth value indicating a maximum possible number of signatures permitted for the artifact. The “maximum possible number” may also be designated as a “limited number”. An established upper limit of signatures, and how often the artifact is capable of being signed, result from this number. This is specified in the metadata.

At the same time, there is also to be the possibility that, starting from a certain signature depth, various data can no longer be changed, by this having been specified in the metadata of the signature, and there is also the possibility that particular subsequent image URLs are restricted by the creator of the signature.

In some embodiments, it can be defined that only particular subsequent signatures are permitted to be applied retrospectively to an image, in particular by a reference to the permissible subsequent signature metadata, or to the issuing certification authorities, being specified, and furthermore by a reference to the public keys of the issuing certification authorities being stored.

The reference might also contain several possible key references, one of which has to have been satisfied in the subsequent steps. In this connection, it might, in addition, be prescribed in each further step by whom a signature has to be provided if the metadata have been specified in such a way that they are always valid for the respective steps. Accordingly, in step 2, signatures of a, b or c; in step 3, signatures of c, d or e, etc.

To the extent that signature depths are defined for the changeability of parameters, or to the extent that the sequence is required, for the subsequent signature services it is necessary that these services do not have to re-sign the complete artifact, inclusive of the data protected by the initial signature, but merely have to include the checksum of the predecessor signature in the calculation of the subsequent signature.

In some embodiments, the artifact features, in addition at least one third parameter, the at least one third parameter being signable by at least one third cryptographic signature. From this it follows that the at least one third parameter does not feature a cryptographic signature, and that the at least one third parameter is modifiable.

In some embodiments, the artifact takes the form of: a container deployment configuration or a container image.

In some embodiments, there is a method for creating an artifact for an instantiation and/or configuration of a container instance for a container runtime environment, including: examining at least one first cryptographic signature which signs a first parameter, depending on an outcome of the examination, creating at least one second cryptographic signature which signs a second parameter, wherein the first parameter and the second parameter are featured by an artifact as claimed in one of the previous claims.

The methods described herein allow a securing of the integrity and authenticity of artifacts such as deployment configurations and container images, and at the same time allows: the changing of individual parameters and metadata that have not been secured as regards integrity and authenticity in subsequent processing steps the restriction to subsequent repositories.

To the extent that an expiration-date of the first or of a later signature is specified, the method can also be temporally limited for defined repositories. The expiration-date can also be used for the purpose of actively looking within the downstream repositories for new versions in the preceding repositories.

By means of the described method, the provider of an artifact can, in addition, restrict more precisely which amendments in subsequent processing steps are permissible in the artifacts or in the metadata.

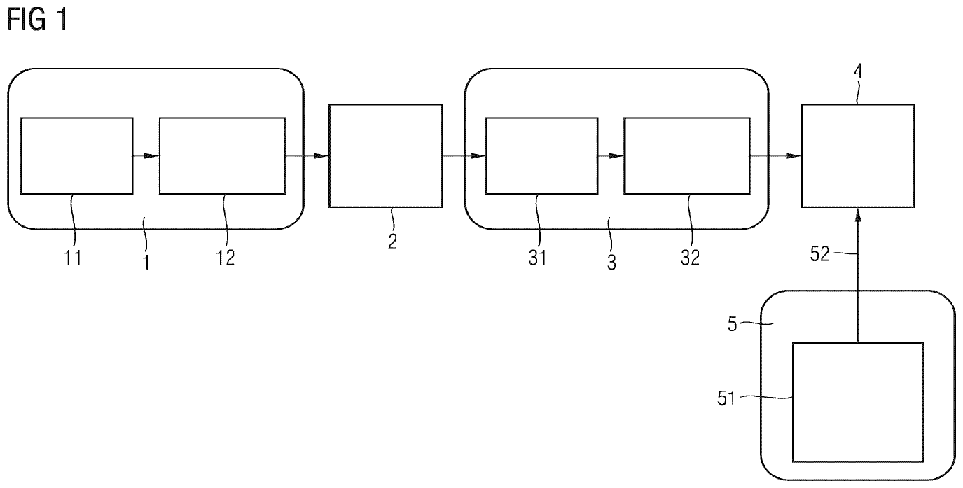

FIG. 1 shows a sequence of operations illustrating how the creator of a container image 11 in his/her developer infrastructure 1 signs his/her artifact 11 in his/her signature service 12 and, in so doing, specifies which areas are to be included in the signature for the purpose of calculating the signature. A deployment infrastructure 1 at the developer contains an artifact 11, in particular a container image 11 or a deployment configuration 11, and a first signing service 12 which is designed to create the first signature of the at least one first parameter.

The artifact 11 is made available in a first registry 2, in particular in an Industrial Edge Hub. In this way, the artifact 11 reaches a central customer-specific infrastructure 3. The latter contains an extension pipeline, in particular of a corporate security team 31 of the customer, and a second signing service 32 which is designed to create the second signature of the at least one second parameter. The artifact 11 is then made available in a second registry 4, in particular in a customer-specific containerized industrial IoT runtime environment.

A runtime environment 51 is made available in a device 5 in a secure customer environment. This runtime environment validates and finally executes the artifact 11.

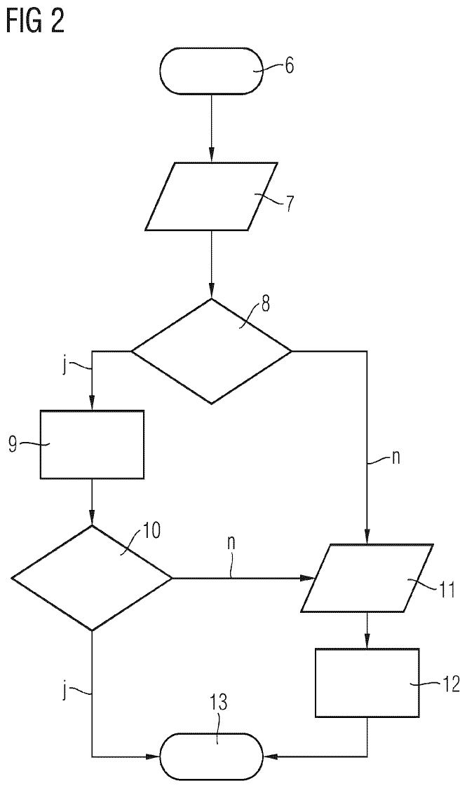

FIG. 2 shows the sequence of operations required for the purpose of creating a second cryptographic signature 12. If the parameters of the subsequent signature are in conflict with the security requirements 11 as regards the integrity and authenticity of the predecessor signature 8, 9, the creation of the subsequent signature is discontinued 13.

In concrete terms, the following are represented in FIG. 2. After the start 6, the artifact 7 to be signed is inspected. There is an examination of whether signatures from previous steps are present 8. If yes, j, an evaluation of the predecessor signature 9 takes place, wherein it is examined whether the parameters protected by the predecessor signature have already been modified. If yes, j, the sequence of operations has been concluded 13. If no, n, the parameter guideline of the artifact 11 is examined, then the implementing of the signature 12 takes place, and the method has been concluded 12.

If no (no, n) signatures from previous steps are present 8, an examination of the parameter guideline of the artifact 11 likewise takes place, then the implementing of the signature 12 takes place, and the method has been concluded 12.

A concrete embodiment example in this connection is constituted by a Docker Compose file, to be signed, of an app of a containerized industrial IoT runtime environment, which is signed by the initial creator and is then uploaded into a central registry which can be made available, in particular, in a central Industrial Edge Hub or in an autonomous app store. In this connection, the creator defines that, for example, the Docker Compose file is only permitted to be made available in downstream registries of a particular customer, and defines this in the integrity-secured and authenticity-secured metadata of the signature. Various possibilities for the reference are conceivable here.
The DNS name may be specified directly
It may be defined that the subsequent signature has to be performed by a private key that was issued by a particular certification authority

At the same time, as described above, it may also be specified that particular parameters are permitted to be changed or added merely in the first downstream registry which, in particular, can be made available in an Industrial Edge Management system. These parameters may be specified either directly or via the specification of regular expressions within the metadata of the first signature. In the subsequent signature instance, it is firstly checked whether the conditions defined in the preceding signature have been satisfied and whether this signature is valid. By means of the validation of the first signature, it is ensured that no further instance has made unauthorized changes between the first signature and the signature to be made now.

If several signatures have been applied, they are validated by being validated in succession. Incompatibilities by reason of incompatible modifications may arise, either by a developer implementing modifications that encompass already signed areas, or by other values, for example as a result of unauthorized modifications, being implemented. In order to detect both modifications directly, it is proposed that they be validated in the same sequence in which they were applied.

If in a processing step (modification+signature procedure) a parameter is changed that is no longer to be changed in subsequent processing steps, the newly introduced parameter is included in the signature.

In order to prevent the creator of a signature from being able to remove the initial signature and consequently deactivating the original validation requirements, it is assumed that a terminal device (container runtime environment or an Industrial Edge device) that performs the validation possesses a defined truststore that defines which possible initial entry signatures a signed artifact (a deployment configuration or an image) has to feature.

For this purpose, the public signature keys of the first registry (for example, an app store or the Industrial Edge Hub) have to be either stored directly or authorized by certification authorities, and the key of the certification authority has to be stored, in order that a validation is possible.

If the validation of the applied signatures in the terminal device fails, the execution of the deployment configuration or of the container image is denied, and an error message is output.

Since previous signature instances may restrict not only amendments in respect of the artifacts themselves (such as, for example, the creation of additional process privileges) in the metadata of the subsequent signature instances, it is also possible that with the described method it can also be ensured that only licensed downstream registry environments are permitted to receive and distribute a dedicated version. To the extent that it is assumed that the runtime environment is trusted, by this means the execution authorization can also be temporally limited by allocation of appropriate metadata in previous signature procedures, by, for instance, an expiration-date being specified in the metadata, and by the instance no longer being able to be restarted with the version made available.

In this connection, it is assumed for the described method that the validation component in the container runtime environment likewise validates the metadata specified with the signature.

By virtue of the provision of an expiration-date and the securing of the integrity and authenticity thereof, it can also be defined that a repository looks in the repository situated above it for a newer version at the latest after a defined expiration-date, and restricts the distribution to subsequent repositories or runtime environments.

Even though the teachings herein have been illustrated and described in detail by means of the embodiment examples, the scope of the disclosure is not limited by the disclosed examples, and other variations can be derived therefrom by a person skilled in the art without departing from the scope of protection thereof.

What is claimed is:

1. An artifact for an instantiation and/or configuration of a container instance for a container runtime environment, the artifact comprising:
a first parameter featuring a first cryptographic signature;
a second parameter; and
an explicit specification of the second parameter with regard to signability by a second cryptographic signature;
wherein the second parameter does not feature a cryptographic signature and/or
the second parameter is modifiable.

2. The artifact as claimed in claim 1, wherein the first cryptographic signature protects the first parameter against modification.

3. The artifact as claimed in claim 1, wherein there is no overlap between the first parameter and the parameter.

4. The artifact as claimed in claim 1, wherein at least one of the first parameter and the second parameter comprise at least one of:
a unique identifier,
a reference,
an initial uniform resource locator,
a container-image uniform resource locator,
an initial container-image tag,
binary-large-object information and
a container-image label.

5. The artifact as claimed in claim 1, wherein the first cryptographic signature specifies the first parameter.

6. The artifact as claimed in claim 1, wherein the artifact and/or the first cryptographic signature includes
metadata,
the metadata specifying the parameter, and/or
the metadata featuring integrity protection and authenticity protection.

7. The artifact as claimed in claim 1, wherein the first cryptographic signature features a reference to the second parameter.

8. The artifact as claimed in claim 1,
further comprising:
a data area featuring the first parameter; and/or
a second data area featuring the second parameter.

9. The artifact as claimed in claim 1, further comprising a signature-depth value assigned to the second signature, the signature-depth value indicating a maximum possible number of signatures permitted for the artifact.

10. The artifact as claimed in claim 1, further comprising
a third parameter signable by a third cryptographic signature.

11. The artifact as claimed in claim 1, wherein the artifact includes:
a container deployment configuration or
a container image.

12-13. (canceled)

14. A method for creating an artifact for an instantiation and/or configuration of a container instance for a container runtime environment, the method comprising:
examining a first cryptographic signature which signs a first parameter; and
depending on an outcome of the examination, creating a second cryptographic signature which signs a second parameter;
wherein the first parameter and the second parameter are featured by an artifact.
